(19) United States
(12) Patent Application Publication
(10) Pub. No.: US 2018/0165762 A1
(43) Pub. Date: Jun. 14, 2018

(54) USER CREDIT ASSESSMENT

(71) Applicant: Alibaba Group Holding Limited, George Town (KY)

(72) Inventor: Wei Du, Hangzhou (CN)

(73) Assignee: Alibaba Group Holding Limited, George Town (KY)

(21) Appl. No.: 15/837,595

(22) Filed: Dec. 11, 2017

(30) Foreign Application Priority Data
Dec. 14, 2016 (CN) 201611155605.3

(51) Int. Cl. G06Q 40/02

(52) U.S. Cl. CPC G06Q 40/025

(57) ABSTRACT

The present disclosure describes techniques for assessing user credit based on credit and propensity information for multiple types of services. One example method includes identifying a plurality of services associated with a credit scoring model corresponding to a type of each service; for each particular service in the plurality of services: determining a credit score of a particular user for the particular service according to the credit scoring model corresponding to the type of the particular service; determining a propensity score of the particular user for the particular service; and after determining credit scores and propensity scores of the particular for each particular service in the plurality of services, determining a comprehensive credit score of the particular user according to the propensity scores of the particular user for various types of services and the credit scores of the particular user for the types of services.

This application claims priority to Chinese Patent Application No. 201611155605.3, filed on Dec. 14, 2016, which is incorporated by reference in its entirety.

### BACKGROUND

The present application relates to the field of Internet technologies, and in particular, to assessing user credit. With rapid development of Internet technologies, increasingly more users implement business operations through the Internet, for example, applying for a loan, applying for a credit card, and so on. Credit of a user has also gradually become an important basis for Internet businesses.

### SUMMARY

The present disclosure describes techniques for assessing user credit based on credit and propensity information for multiple types of services.

In an implementation, a plurality of services are identified, each of the plurality of services associated with a credit scoring model corresponding to a type of each service. For each particular service in the plurality of services: a credit score of a particular user is determined for the particular service according to the credit scoring model corresponding to the type of the particular service, wherein the credit score is determined based on credit information about the particular user required by the credit scoring model corresponding to the type of the particular service. A propensity score of the particular user is determined for the particular service, the propensity score representing a degree of preference of the particular user for the type of the particular service, wherein the propensity score is determined based on propensity information about the particular user associated with the type of the particular service. After determining credit scores and propensity scores of the particular for each particular service in the plurality of services, a comprehensive credit score of the particular user is determined according to the propensity scores of the particular user for various types of services and the credit scores of the particular user for the types of services.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. The present techniques may produce a more accurate representation of the credit worthiness of a particular user by taking into account multiple credit scores calculated according to credit models specific to different types of services. Behavioral characteristics of the particular user may also be taken into account, which may further increase the accuracy of the representation of the credit worthiness of a particular user.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flowchart illustrating an example of a computer-implemented method for assessing user credit, according to an implementation of the present disclosure.

FIG. 2 is a schematic structural diagram of a user credit assessing apparatus, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes assessing user credit, and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined can be applied to other implementations and applications, without departing from the scope of the present disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

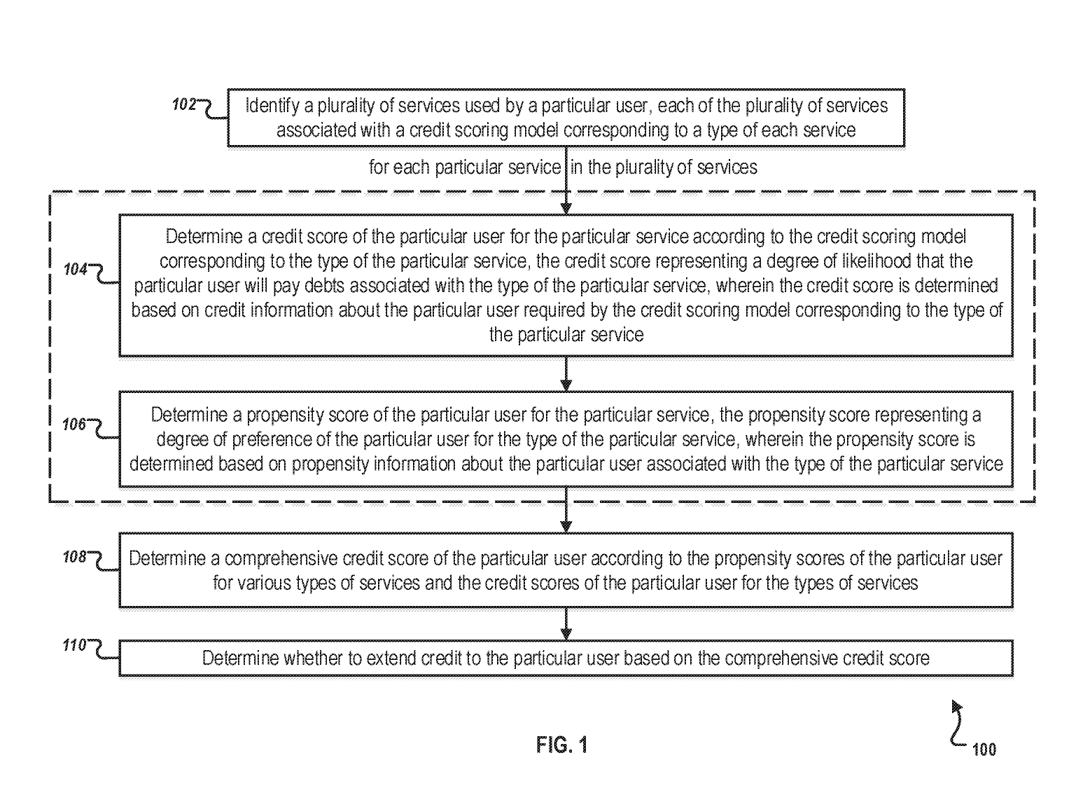

FIG. 1 is a flowchart illustrating an example of a computer-implemented method 100 for assessing user credit, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

At 102, a plurality of services used by a particular user are identified, each of the plurality of services associated with a credit scoring model corresponding to a type of each service. From 102, method 100 proceeds to 104. Steps 104 and 106 are repeated for each of the identified plurality of services.

At 104, a credit score of the particular user for the particular service is determined according to the credit scoring model corresponding to the type of the particular service, the credit score representing a degree of likelihood that the particular user will pay debts associated with the type of the particular service, wherein the credit score is determined based on credit information about the particular user required by the credit scoring model corresponding to the type of the particular service. From 104, method 100 proceeds to 106.

At 106, a propensity score of the particular user for the particular service is determined, the propensity score representing a degree of preference of the particular user for the type of the particular service, wherein the propensity score is determined based on propensity information about the particular user associated with the type of the particular service. From 106, method 100 proceeds to 108.

At 108, a comprehensive credit score of the particular user is determined according to the propensity scores of the particular user for various types of services and the credit scores of the particular user for the types of services. From 108, method 100 proceeds to 110.

At 112, a determination whether to extend credit to the particular user is made based on the comprehensive credit score. After 120, method 100 stops.

In the operation of method 100, as different types of services usually have different customer bases and credit manifestations of customers also differ greatly, in order to improve the universality of the credit scoring model, different credit scoring models may be established for customer bases of different types of services. For example, a credit scoring model M1 is established for a customer base of a loan service, a credit scoring model M2 is established for a customer base of a credit card application service, and so on. On the assumption that all services may be classified into N types, a credit scoring model corresponding to the ith type of service may be recorded as Mi.

In method 100, a target user is a user who requires credit scoring. In some implementations, the credit information may include: age, occupation, usual place of residence, historical service information, and so on. Then, credit scores of the target user in various types of services may be calculated according to the credit information. Specifically, for the ith type of service, the credit score Si of the target user in the service may be calculated according to the credit scoring model Mi of the service and the first type of feature information values of the target user, wherein i is a natural number not greater than N.

Credit scoring models corresponding to different types of services may be different, and therefore the credit information required to calculate the credit scores of the target user in different types of services may be the same or different, depending on the corresponding credit scoring model.

In some implementations, the propensity score Pi may reflect a degree of preference of the target user to the ith type of service. In other words, the propensity score Pi may be used to reflect a probability that the target user uses the ith type of service. Generally, the higher the propensity score of the target user to a certain type of service is, the greater the probability that the target user uses the type of service is.

In some cases, the propensity scores of the target user for various types of services may be calculated. Weighted summation may be performed on the propensity information according to feature weights of the propensity information in various dimensions in the ith type of service to obtain the propensity score Pi of the target user for the service.

The propensity information may be the same as or different from the credit information, which may be specifically set by a developer according to a business condition. The propensity information may include quantifications of the information. For example, if the propensity information includes an occupation, a lawyer may be quantified to the number 3, a white-collar worker may be quantified to the number 2, a student may be quantified to the number 1, and so on.

In some implementations, the propensity information in ten dimensions of the target user are required when the propensity score for the ith type is calculated. The propensity information values of the target user in the ten dimensions are f1, f2, . . . , f10 respectively, and the feature weights corresponding to the propensity information in various dimensions when the propensity score for the ith type is calculated are k1, k2, . . . , k10 respectively; therefore, the propensity score of the target user for the ith type of service is Pi=Σⱼ₌₁¹⁰fⱼ×kⱼ. Similarly, propensity scores of the target user for various types of services may be calculated.

In some cases, the feature weights of the propensity information in various dimensions corresponding to different types of services may be different, that is, values of Kj corresponding to different types of services are usually different, which may be specifically set by the developer according to an actual condition of the business.

In some implementations, other methods may also be adopted to calculate the propensity scores of the target user for various types of services. For example, the propensity scores of the target user for corresponding types of services may be calculated according to a similarity degree between the propensity information of historical users of various types of services and the propensity information of the target user, which is not specifically limited in the present application.

In some implementations, a credit manifestation of the target user in a preferred service may determine a final credit score of the target user to a large extent. Further, a comprehensive credit score of the target user may be obtained by performing weighted summation on the credit scores of the user in various types of services according to the propensity scores.

The above implementations may produce a comprehensive credit score having better flexibility and higher universality. Moreover, the comprehensive credit score obtained by calculation also has a higher accuracy.

In some cases, for the ith type of service, a scoring weight Wi of the target user in the service may further be calculated according to a historical usage condition of the service by the users whose propensity scores are all Pi; then, weighted summation may be performed on the credit scores of the target user in various types of services according to the scoring weight Wi of the target user in the ith type of service, and a result of the weighted summation is determined as the comprehensive credit score of the target user.

Specifically, after the propensity score Pi of the target user for the ith type of service has been calculated, the scoring weight Wi of the target user in the service may be calculated, and the scoring weight Wi may also reflect preference of the target user to the type of service. In some cases, the higher the scoring weight of the target in a certain type of service is, the greater the probability that the target user uses the type of service is.

Taking the ith type of service as an example, the number of users whose propensity scores are all Pi may be counted as a total number, the number of users who have used the service in the users whose propensity scores are all Pi may be counted as a usage number, and then a scoring weight Wi of the target user in the service is obtained by dividing the usage number by the total number.

For example, assume that a propensity score of a target user for the ith type of service is 65. In some implementations, a total number of users whose propensity scores for the ith type of service are all 65 may be counted at first. Also assume that, among all users, there are 100 users whose propensity scores for the ith type of service are 65, but 60 users among the 100 users have ever used the ith type of service, then the scoring weight of the target user in the ith type of service is Wi=60/100, that is, Wi=0.6. In some cases, for a certain type of service, scoring weights of users with the same propensity score in the service are also the same.

In another example, when the scoring weight is calculated, the number of users may also be counted according to a preset propensity score interval. Assuming that the propensity score of a target user for the ith type of service is 65, a total number of users whose propensity scores for the ith type of service are all 60-65 may be counted. Assume that there are 200 users, but 150 users among the 200 users have ever used the ith type of service, then the scoring weight of the target user in the ith type of service Wi=150/200, that is, Wi=0.75.

In some implementations, the scoring weight Wi may be calculated according to the propensity score Pi by using other methods, which is not specifically limited in the present application.

As described above, propensity scores of a user for various types of services may be determined according to propensity information of the user, scoring weights of the user in various types of services may be determined according to the propensity scores, weighted summation on credit scores of the user in various types of services may be determined according to the corresponding scoring weights, and a comprehensive credit score of the user may be calculated according to behavioral preference of the user. The present application has better flexibility and higher universality. Moreover, the comprehensive credit score obtained by calculation also has a higher accuracy.

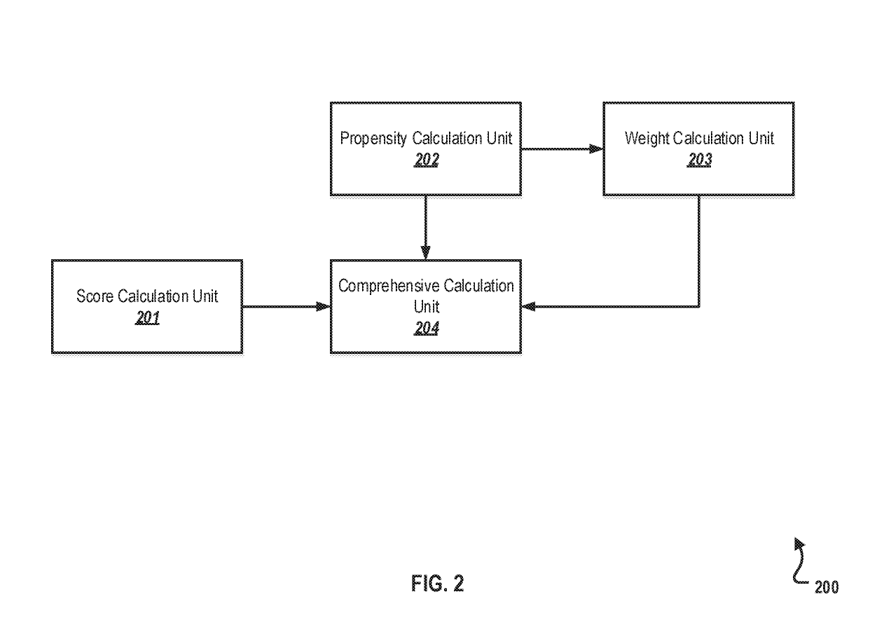

FIG. 2 is a schematic structural diagram of a user credit assessing apparatus, according to an implementation of the present disclosure. Referring to FIG. 2, the score calculation unit 201 is configured to, for each type of service, acquire credit information corresponding to a target user according to a first type of credit information required by a credit scoring model corresponding to the type of service, and calculate a credit score S of the target user in the service based on the credit first type of feature information values and the credit scoring model;

The propensity calculation unit 202 is configured to, for each type of service, acquire propensity information corresponding to the target user required by the type of service when a propensity score P of the target user for the service is calculated, and calculate the propensity score P of the target user for the service based on the propensity information, the propensity score Pi reflecting a degree of preference of the target user to the particular type of service.

The comprehensive calculation unit 204 is configured to calculate a comprehensive credit score of the target user according to propensity scores of the target user for various types of services and credit scores of the target user in various types of services.

In some cases, the comprehensive credit score CS is calculated according to the formula CS=Σᵢ₌₁^{N} Pi×Si, wherein i is a natural number not greater than N, and N is the number of service types, Si is the credit score for a service numbered i, and Pi is the propensity score for the service numbered i.

In some cases, the comprehensive calculation unit 204 is specifically configured to perform weighted summation on the credit scores of the target user in various types of services according to the propensity score P of the target user for the particular type of service, and determine a result of the weighted summation as the comprehensive credit score of the target user.

The weight calculation unit 203 is configured to, for the ith type of service, calculate a scoring weight Wi of the target user in the service according to the propensity score Pi, wherein Wi is positively correlated with Pi. In some cases, the comprehensive credit score CS is calculated according to the formula CS=Σᵢ₌₁^{N} Wi×Si.

In some implementations, the propensity calculation unit 202 is configured to perform weighted summation on the second type of feature information values of the target user according to feature weights of the second type of feature information in various dimensions in the ith type of service to obtain the propensity score Pi of the target user for the service.

In some implementations, the weight calculation unit 203 is configured to, for the ith type of service, count the number of users whose propensity scores are all Pi as a total number; for the ith type of service, count the number of users who have used the service in the users whose propensity scores are all Pi as a usage number; and obtain a scoring weight Wi of the target user in the service by dividing the usage number by the total number.

In some cases, the feature information includes: age, occupation, usual place of residence, and historical business information.

In some implementations, different types of services have different credit scoring models.

Reference may be specifically made to the implementation process of the corresponding steps in the method for the implementation process of functions and effects of the units in the apparatus, and details thereof are not described herein.

The apparatus embodiment is basically similar to the method embodiment, so, for related parts, refer to the description of the parts in the method embodiment. The apparatus embodiment described above is merely schematic. The units described as separate parts may or may not be physically separate, and parts displayed as units may or may not be physical units, may be located in one position, or may be distributed to a plurality of network units. Some or all of the modules may be selected according to actual needs to achieve the objectives of the solutions of the present application. Those of ordinary skill in the art may understand and implement the present application without making creative efforts.

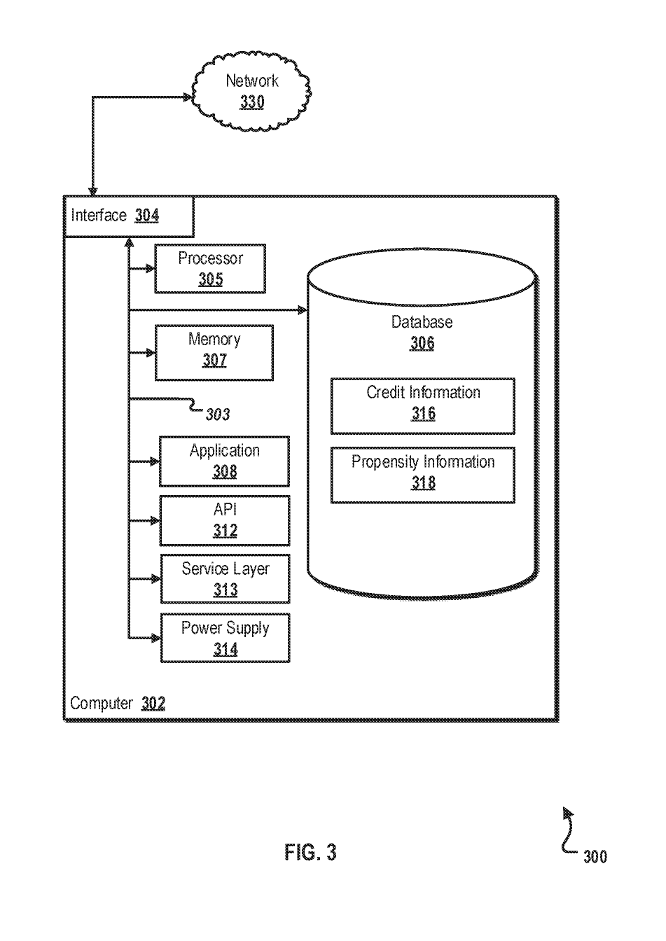

FIG. 3 is a block diagram illustrating an example of a computer-implemented system 300 used to provide computational functionalities associated with described algorithms, methods, functions, processes, flows, and procedures, according to an implementation of the present disclosure. In the illustrated implementation, system 300 includes a computer 302 and a network 330.

The illustrated computer 302 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the computer 302 can include an input device, such as a keypad, keyboard, touch screen, another input device, or a combination of input devices that can accept user information, and an output device that conveys information associated with the operation of the computer 302, including digital data, visual, audio, another type of information, or a combination of types of information, on a graphical-type user interface (UI) (or GUI) or other UI.

The computer 302 can serve in a role in a distributed computing system as a client, network component, a server, a database or another persistency, another role, or a combination of roles for performing the subject matter described in the present disclosure. The illustrated computer 302 is communicably coupled with a network 330. In some implementations, one or more components of the computer 302 can be configured to operate within an environment, including cloud-computing-based, local, global, another environment, or a combination of environments.

At a high level, the computer 302 is an electronic computing device operable to receive, transmit, process, store, or manage data and information associated with the described subject matter. According to some implementations, the computer 302 can also include or be communicably coupled with a server, including an application server, e-mail server, web server, caching server, streaming data server, another server, or a combination of servers.

The computer 302 can receive requests over network 330 (for example, from a client software application executing on another computer 302) and respond to the received requests by processing the received requests using a software application or a combination of software applications. In addition, requests can also be sent to the computer 302 from internal users (for example, from a command console or by another internal access method), external or third-parties, or other entities, individuals, systems, or computers.

Each of the components of the computer 302 can communicate using a system bus 303. In some implementations, any or all of the components of the computer 302, including hardware, software, or a combination of hardware and software, can interface over the system bus 303 using an application programming interface (API) 312, a service layer 313, or a combination of the API 312 and service layer 313. The API 312 can include specifications for routines, data structures, and object classes. The API 312 can be either computer-language independent or dependent and refer to a complete interface, a single function, or even a set of APIs. The service layer 313 provides software services to the computer 302 or other components (whether illustrated or not) that are communicably coupled to the computer 302. The functionality of the computer 302 can be accessible for all service consumers using this service layer. Software services, such as those provided by the service layer 313, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 302, alternative implementations can illustrate the API 312 or the service layer 313 as stand-alone components in relation to other components of the computer 302 or other components (whether illustrated or not) that are communicably coupled to the computer 302. Moreover, any or all parts of the API 312 or the service layer 313 can be implemented as a child or a sub-module of another software module, enterprise application, or hardware module without departing from the scope of the present disclosure.

The computer 302 includes an interface 304. Although illustrated as a single interface 304 in FIG. 3, two or more interfaces 304 can be used according to particular needs, desires, or particular implementations of the computer 302. The interface 304 is used by the computer 302 for communicating with another computing system (whether illustrated or not) that is communicatively linked to the network 330 in a distributed environment. Generally, the interface 304 is operable to communicate with the network 330 and includes logic encoded in software, hardware, or a combination of software and hardware. More specifically, the interface 304 can include software supporting one or more communication protocols associated with communications such that the network 330 or interface's hardware is operable to communicate physical signals within and outside of the illustrated computer 302.

The computer 302 includes a processor 305. Although illustrated as a single processor 305 in FIG. 3, two or more processors can be used according to particular needs, desires, or particular implementations of the computer 302. Generally, the processor 305 executes instructions and manipulates data to perform the operations of the computer 302 and any algorithms, methods, functions, processes, flows, and procedures as described in the present disclosure.

The computer 302 also includes a database 306 that can hold data for the computer 302, another component communicatively linked to the network 330 (whether illustrated or not), or a combination of the computer 302 and another component. For example, database 306 can be an in-memory, conventional, or another type of database storing data consistent with the present disclosure. In some implementations, database 306 can be a combination of two or more different database types (for example, a hybrid in-memory and conventional database) according to particular needs, desires, or particular implementations of the computer 302 and the described functionality. Although illustrated as a single database 306 in FIG. 3, two or more databases of similar or differing types can be used according to particular needs, desires, or particular implementations of the computer 302 and the described functionality. While database 306 is illustrated as an integral component of the computer 302, in alternative implementations, database 306 can be external to the computer 302. As illustrated, the database 306 holds the previously described credit information and propensity information.

The computer 302 also includes a memory 307 that can hold data for the computer 302, another component or components communicatively linked to the network 330 (whether illustrated or not), or a combination of the computer 302 and another component. Memory 307 can store any data consistent with the present disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307 in FIG. 3, two or more memories 307 or similar or differing types can be used according to particular needs, desires, or particular implementations of the computer 302 and the described functionality. While memory 307 is illustrated as an integral component of the computer 302, in alternative implementations, memory 307 can be external to the computer 302.

The application 308 is an algorithmic software engine providing functionality according to particular needs, desires, or particular implementations of the computer 302, particularly with respect to functionality described in the present disclosure. For example, application 308 can serve as one or more components, modules, or applications. Further, although illustrated as a single application 308, the application 308 can be implemented as multiple applications 308 on the computer 302. In addition, although illustrated as integral to the computer 302, in alternative implementations, the application 308 can be external to the computer 302.

The computer 302 can also include a power supply 314. The power supply 314 can include a rechargeable or non-rechargeable battery that can be configured to be either user- or non-user-replaceable. In some implementations, the power supply 314 can include power-conversion or management circuits (including recharging, standby, or another power management functionality). In some implementations, the power-supply 314 can include a power plug to allow the computer 302 to be plugged into a wall socket or another power source to, for example, power the computer 302 or recharge a rechargeable battery.

There can be any number of computers 302 associated with, or external to, a computer system containing computer 302, each computer 302 communicating over network 330. Further, the term “client,” “user,” or other appropriate terminology can be used interchangeably, as appropriate, without departing from the scope of the present disclosure. Moreover, the present disclosure contemplates that many users can use one computer 302, or that one user can use multiple computers 302.

Described implementations of the subject matter can include one or more features, alone or in combination.

For example, in a first implementation, a plurality of services are identified, each of the plurality of services associated with a credit scoring model corresponding to a type of each service. For each particular service in the plurality of services: a credit score of a particular user is determined for the particular service according to the credit scoring model corresponding to the type of the particular service, wherein the credit score is determined based on credit information about the particular user required by the credit scoring model corresponding to the type of the particular service. A propensity score of the particular user is determined for the particular service, the propensity score representing a degree of preference of the particular user for the type of the particular service, wherein the propensity score is determined based on propensity information about the particular user associated with the type of the particular service. After determining credit scores and propensity scores of the particular for each particular service in the plurality of services, a comprehensive credit score of the particular user is determined according to the propensity scores of the particular user for various types of services and the credit scores of the particular user for the types of services.

The foregoing and other described implementations can each, optionally, include one or more of the following features:

A first feature, combinable with any of the following features, in which i is a natural number not greater than N, and N is the number of service types, Si is the credit score for a service numbered i, and Pi is the propensity score for the service numbered i, and the comprehensive credit score CS is calculated according to the formula CS=Σᵢ₌₁^{N} Pi×Si.

A second feature, combinable with any of the following features, in which calculating a comprehensive credit score of the particular user includes: performing a weighted summation on the credit scores of the particular user for the types of services according to the propensity scores of the target user for the types of services, and determining a result of the weighted summation as the comprehensive credit score of the target user.

A third feature, combinable with any of the following features, in which i is a natural number not greater than N, and N is the number of service types, Si is the credit score for a service numbered i, Pi is the propensity score for the service numbered i, determining a comprehensive credit score of the particular user includes calculating a scoring weight Wi of the particular user for the particular service according to the propensity score Pi, wherein Wi is positively correlated with Pi, and the comprehensive credit score CS is calculated according to the formula CS=Σᵢ₌₁^{N} Wi×Si.

A fourth feature, combinable with any of the following features, in which calculating the scoring weight Wi of the particular user includes: counting the number of users whose propensity scores for the type of the particular service are all Pi as a total number; counting the number of users who have used the service in the users whose propensity scores are all Pi as a usage number; and obtaining a scoring weight Wi of the particular user in the service by dividing the usage number by the total number.

A fifth feature, combinable with any of the following features, wherein the credit information includes at least one of age, occupation, usual place of residence, or historical business information.

A sixth feature, combinable with any of the following features, each type of service is associated with a different credit scoring model.

In a second implementation, a non-transitory, computer-readable medium stores one or more instructions executable by a computer system to perform the following operations. A plurality of services are identified, each of the plurality of services associated with a credit scoring model corresponding to a type of each service. For each particular service in the plurality of services: a credit score of a particular user is determined for the particular service according to the credit scoring model corresponding to the type of the particular service, wherein the credit score is determined based on credit information about the particular user required by the credit scoring model corresponding to the type of the particular service. A propensity score of the particular user is determined for the particular service, the propensity score representing a degree of preference of the particular user for the type of the particular service, wherein the propensity score is determined based on propensity information about the particular user associated with the type of the particular service. After determining credit scores and propensity scores of the particular for each particular service in the plurality of services, a comprehensive credit score of the particular user is determined according to the propensity scores of the particular user for various types of services and the credit scores of the particular user for the types of services.

In a third implementation, a computer-implemented system includes one or more computers, and one or more computer memory devices interoperably coupled with the one or more computers and having tangible, non-transitory, machine-readable media storing one or more instructions that, when executed by the one or more computers, perform the following operations. A plurality of services are identified, each of the plurality of services associated with a credit scoring model corresponding to a type of each service. For each particular service in the plurality of services: a credit score of a particular user is determined for the particular service according to the credit scoring model corresponding to the type of the particular service, wherein the credit score is determined based on credit information about the particular user required by the credit scoring model corresponding to the type of the particular service. A propensity score of the particular user is determined for the particular service, the propensity score representing a degree of preference of the particular user for the type of the particular service, wherein the propensity score is determined based on propensity information about the particular user associated with the type of the particular service. After determining credit scores and propensity scores of the particular for each particular service in the plurality of services, a comprehensive credit score of the particular user is determined according to the propensity scores of the particular user for various types of services and the credit scores of the particular user for the types of services.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatus, devices, and machines for processing data, including by way of example, a programmable processor, a computer, or multiple processors or computers. The computer can also be, or further include special purpose logic circuitry, for example, a central processing unit (CPU), an FPGA (field programmable gate array), or an ASIC (application-specific integrated circuit). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

The described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
identifying a plurality of services, each of the plurality of services associated with a credit scoring model corresponding to a type of each service;
for each particular service in the plurality of services:
determining a credit score of a particular user for the particular service according to the credit scoring model corresponding to the type of the particular service, wherein the credit score is determined based on credit information about the particular user required by the credit scoring model corresponding to the type of the particular service;
determining a propensity score of the particular user for the particular service, the propensity score representing a degree of preference of the particular user for the type of the particular service, wherein the propensity score is determined based on propensity information about the particular user associated with the type of the particular service; and
after determining credit scores and propensity scores of the particular for each particular service in the plurality of services, determining a comprehensive credit score of the particular user according to the propensity scores of the particular user for various types of services and the credit scores of the particular user for the types of services.

2. The method of claim 1, wherein i is a natural number not greater than N, and N is the number of service types, Si is the credit score for a service numbered i, and Pi is the propensity score for the service numbered i, and the comprehensive credit score CS is calculated according to the formula CS=Σᵢ₌₁^{N} Pi×Si.

3. The method of claim 1, wherein calculating a comprehensive credit score of the particular user includes:
performing a weighted summation on the credit scores of the particular user for the types of services according to the propensity scores of the target user for the types of services, and determining a result of the weighted summation as the comprehensive credit score of the particular user.

4. The method of claim 3, wherein:
i is a natural number not greater than N, and N is the number of service types,
Si is the credit score for a service numbered i,
Pi is the propensity score for the service numbered i,
determining a comprehensive credit score of the particular user includes calculating a scoring weight Wi of the particular user for the particular service according to the propensity score Pi, wherein Wi is positively correlated with Pi, and the comprehensive credit score CS is calculated according to the formula CS=Σᵢ₌₁^{N} Wi×Si.

5. The method of claim 4, wherein calculating the scoring weight Wi of the particular user includes:
counting the number of users whose propensity scores for the type of the particular service are all Pi as a total number;
counting the number of users who have used the service in the users whose propensity scores are all Pi as a usage number; and
obtaining a scoring weight Wi of the particular user in the service by dividing the usage number by the total number.

6. The method of claim 1, wherein the credit information includes at least one of age, occupation, usual place of residence, or historical business information.

7. The method of claim 1, wherein each type of service is associated with a different credit scoring model.

8. A non-transitory, computer-readable medium storing one or more instructions executable by a computer system to perform operations comprising:
identifying a plurality of services, each of the plurality of services associated with a credit scoring model corresponding to a type of each service;
for each particular service in the plurality of services:
determining a credit score of a particular user for the particular service according to the credit scoring model corresponding to the type of the particular service, wherein the credit score is determined based on credit information about the particular user required by the credit scoring model corresponding to the type of the particular service;
determining a propensity score of the particular user for the particular service, the propensity score representing a degree of preference of the particular user for the type of the particular service, wherein the propensity score is determined based on propensity information about the particular user associated with the type of the particular service; and
after determining credit scores and propensity scores of the particular for each particular service in the plurality of services, determining a comprehensive credit score of the particular user according to the propensity scores of the particular user for various types of services and the credit scores of the particular user for the types of services.

9. The non-transitory, computer-readable medium of claim 8, wherein i is a natural number not greater than N, and N is the number of service types, Si is the credit score for a service numbered i, and Pi is the propensity score for the service numbered i, and the comprehensive credit score CS is calculated according to the formula CS=Σᵢ₌₁^{N} Pi×Si.

10. The non-transitory, computer-readable medium of claim 8, wherein calculating a comprehensive credit score of the particular user includes:
performing a weighted summation on the credit scores of the particular user for the types of services according to the propensity scores of the target user for the types of services, and determining a result of the weighted summation as the comprehensive credit score of the particular user.

11. The non-transitory, computer-readable medium of claim 10, wherein:
i is a natural number not greater than N, and N is the number of service types,
Si is the credit score for a service numbered i,
Pi is the propensity score for the service numbered i,
determining a comprehensive credit score of the particular user includes calculating a scoring weight Wi of the particular user for the particular service according to the propensity score Pi, wherein Wi is positively correlated with Pi, and the comprehensive credit score CS is calculated according to the formula CS=Σᵢ₌₁^{N} Wi×Si.

12. The non-transitory, computer-readable medium of claim 11, wherein calculating the scoring weight Wi of the particular user includes:
counting the number of users whose propensity scores for the type of the particular service are all Pi as a total number;
counting the number of users who have used the service in the users whose propensity scores are all Pi as a usage number; and
obtaining a scoring weight Wi of the particular user in the service by dividing the usage number by the total number.

13. The non-transitory, computer-readable medium of claim 8, wherein the credit information includes at least one of age, occupation, usual place of residence, or historical business information.

14. The non-transitory, computer-readable medium of claim 8, wherein each type of service is associated with a different credit scoring model.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying a plurality of services, each of the plurality of services associated with a credit scoring model corresponding to a type of each service;
for each particular service in the plurality of services:
determining a credit score of a particular user for the particular service according to the credit scoring model corresponding to the type of the particular service, wherein the credit score is determined based on credit information about the particular user required by the credit scoring model corresponding to the type of the particular service;
determining a propensity score of the particular user for the particular service, the propensity score representing a degree of preference of the particular user for the type of the particular service, wherein the propensity score is determined based on propensity information about the particular user associated with the type of the particular service; and
after determining credit scores and propensity scores of the particular for each particular service in the plurality of services, determining a comprehensive credit score of the particular user according to the propensity scores of the particular user for various types of services and the credit scores of the particular user for the types of services.

16. The computer-implemented system of claim 15, wherein i is a natural number not greater than N, and N is the number of service types, Si is the credit score for a service numbered i, and Pi is the propensity score for the service numbered i, and the comprehensive credit score CS is calculated according to the formula CS=Σᵢ₌₁^{N} Pi×Si.

17. The computer-implemented system of claim 15, wherein calculating a comprehensive credit score of the particular user includes:
performing a weighted summation on the credit scores of the particular user for the types of services according to the propensity scores of the target user for the types of services, and determining a result of the weighted summation as the comprehensive credit score of the particular user.

18. The computer-implemented system of claim 17, wherein:
i is a natural number not greater than N, and N is the number of service types,
Si is the credit score for a service numbered i,
Pi is the propensity score for the service numbered i,
determining a comprehensive credit score of the particular user includes calculating a scoring weight Wi of the particular user for the particular service according to the propensity score Pi, wherein Wi is positively correlated with Pi, and the comprehensive credit score CS is calculated according to the formula CS=Σᵢ₌₁^{N} Wi×Si.

19. The computer-implemented system of claim 18, wherein calculating the scoring weight Wi of the particular user includes:
counting the number of users whose propensity scores for the type of the particular service are all Pi as a total number;
counting the number of users who have used the service in the users whose propensity scores are all Pi as a usage number; and
obtaining a scoring weight Wi of the particular user in the service by dividing the usage number by the total number.

20. The computer-implemented system of claim 15, wherein the credit information includes at least one of age, occupation, usual place of residence, or historical business information.
